(19) United States
(12) Patent Application Publication
(10) Pub. No.: US 2024/0084187 A1
(43) Pub. Date: Mar. 14, 2024

(54) SMART, RECOVERABLE DELIVERY VEHICLES FOR SITE-SPECIFIC AND FUNCTION-SPECIFIC PRECISION DELIVERY OF SUB-MICRON CARGO FOR THE ENHANCED OIL RECOVERY

(71) Applicant: BioSystOmics Inc., Houston, TX (US)

(72) Inventor: Naveed Aslam, Houston, TX (US)

(73) Assignee: BioSystOmics Inc., Houston, TX (US)

(21) Appl. No.: 18/513,355

(22) Filed: Nov. 17, 2023

Related U.S. Application Data
(63) Continuation-in-part of application No. 17/576,927, filed on Jan. 15, 2022.

(51) Int. Cl. C09K 8/58; E21B 43/16

(52) U.S. Cl. CPC C09K 8/58; E21B 43/16

(57) ABSTRACT

Embodiments of the instant disclosure relate to a delivery vehicle for site-specific and function-specific precision delivery of sub-micron cargo for petroleum recovery. The delivery vehicle includes an outer shell, inner core, channel, functional cargo, and stimulus-responsive polymer. The delivery vehicle is configured to be mixed with a dispersion fluid and injected into a subterranean residual oil zone. The outer shell is negatively charged and includes graphene sheets interlocked together in a manner to form a spherical structure. The channel traverses the outer shell and terminates at the inner core. The functional cargo absorbs petroleum. The stimulus-responsive polymer is externally positioned on the outer shell and is functionally coupled to and selectively blocks the channel. The stimulus-responsive polymer is configured to unblock the channel when a stimulus is received and thereby allows release of the functional cargo from the inner core via the channel into the subterranean residual oil zone.

### CROSS-REFERENCE TO RELATED APPLICATIONS

This application is a continuation-in-part of U.S. patent application Ser. No. 17/576,927, filed Jan. 15, 2023. This application is hereby incorporated herein by reference.

### BACKGROUND

The instant disclosure relates generally to petroleum oil (“oil”) recovery and specifically to recoverable delivery vehicles for oil recovery. Recovery of oil from oil-bearing subterranean formations may pose certain challenges as the primary phase of recovery comes to a completion. The primary recovery phase is driven by the intrinsic energy of a reservoir. Once this energy is expended, external intervention in the form of materials and energy are needed to extract additional oil. For example, the simplest and lowest cost intervention often involves water or steam injection. However, simple water and steam injection has certain limitations and beyond that point their influence on overall oil recovery is minimal or incremental despite continual injection of large pore volumes of stimulant fluid. This secondary phase of reservoir life is usually followed by a more complex and expensive tertiary phase that may involve gases, surfactants, polymers, nanoparticles, and other specialized additives.

One of the major challenges of oil recovery in the post-primary phase is the specific delivery of additives (e.g., surfactants, polymers, and nanoparticles) precisely at the sites where oil is trapped or adsorbed or accumulated within the pores of reservoir rocks. Due to salinity, heat, and rough rock surfaces, the losses of such additives can be significant and, in turn, also adversely influence the overall economics of the recovery while raising red flags due to the possibility of adverse environmental influence of these materials. The ultrafine sub-micronscale and nanoscale materials can provide intriguing possibilities to enhance the development of mature fields in conventional and unconventional reservoirs. The application of these materials can stimulate the recovery of oil from conventional and unconventional reservoirs.

The finer scale materials can boost the recovery of oil from subterranean geological formations (e.g., by exerting disjoining pressure, altering wettability, and/or reducing surface tension). Such ultrafine materials are currently in use at field scale in applications like enhanced oil recovery (“EOR”), improved oil recovery (“IOR”), and fracturing. However, these materials are limited due to their ability to exhibit van der Waals attractions and thereby cause the particles to aggregate into large particle clusters, which reduces their surface area and the advantages associated with ultrafine scale entities disappear.

Thus, the application of these materials requires some sort of surface wrapping or coatings such that steric repulsion between particles is created and thus particles are stabilized due to charge distribution associated with surface treatments. The successful upstream applications of EOR or fracturing applications of these entities involve surface functionalization. However, due to harsh reservoir conditions of salinity and heat the surface functionalities are prone to degradation, which thereby reduces the efficacy of the nanoparticles in EOR and fracturing. This is apparent as only a third of all the wells are able to respond to treatments based on nanofluids. In such systems, the efficacy rapidly declines and typically requires additional rounds of treatment, which substantially increases the recovery cost. The consumer would benefit from a smart, lower cost, function-specific, scalable, and site-specific delivery method of ultrafine materials of sub-micron scale and nanoscale to enhance EOR/IOR efforts.

### BRIEF DESCRIPTION OF THE DRAWINGS

FIG. 1 depicts a sectional view of a smart, recoverable delivery vehicle (“delivery vehicle”) for site-specific and function-specific precise delivery of sub-micron particles for enhanced oil recovery, according to some embodiments.

FIG. 2 depicts a sectional view of a delivery vehicle, according to other embodiments.

FIG. 3A depicts a sectional view of a delivery vehicle, in accordance with certain embodiments.

FIG. 3B illustrates a charge distribution profile of a delivery vehicle, generally 355 that includes uni-functional cargo, in accordance with yet still other embodiments.

FIG. 4 depicts a sectional view of a delivery vehicle, in accordance with some embodiments.

FIG. 5A depicts a flooding mechanism that uses the delivery vehicles of the instant disclosure for oil recovery in a subterranean residual oil zone, in accordance with other embodiments.

FIG. 5B illustrates operational steps of a method for recovering oil, in accordance with some embodiments.

FIG. 6A depicts a sectional view of a delivery vehicle, in accordance with certain embodiments.

FIG. 6B illustrates a charge distribution profile of the delivery vehicle of FIG. 6A, in accordance with yet still other embodiments.

FIG. 7A depicts a process for generating delivery vehicles, in accordance with some embodiments.

FIG. 7B illustrates operational steps of a method for the process of FIG. 7A, in accordance with certain embodiments.

FIG. 8 depicts a process for generating graphene balls, in accordance with other embodiments.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain terminology may be employed in the following description for convenience rather than for any limiting purpose. For example, “top” and “bottom” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “horizontal” and “axial” or “vertical” referring, respectively, to directions or planes which are perpendicular, in the case of radial or horizontal, or parallel, in the case of axial or vertical, to the longitudinal central axis of the referenced element, the terms “proximate” and “distal” referring, respectively, to positions or locations that are close or away from a point of reference, and the terms “downstream” and “upstream” referring, respectively, to directions in and opposite that of fluid flow. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows. Angles may be designated as “included” as measured relative to surfaces or axes of an element and as defining a space bounded internally within such element therebetween, or otherwise without such designation as being measured relative to surfaces or axes of an element and as defining a space bounded externally by or outside of such element therebetween. Generally, the measures of the angles stated are as determined relative to a common axis, which axis may be transposed in the figures for purposes of convenience in projecting the vertex of an angle defined between the axis and a surface which otherwise does not extend to the axis. The term “axis” may refer to a line or to a transverse plane through such line as will be apparent from context.

The instant disclosure seeks to provide a smart, lower cost, function-specific, scalable, and site-specific delivery method of ultrafine materials of sub-micron scale and nanoscale for oil recovery. The instant disclosure further seeks to provide oil recovery methods that can utilize non-surface functionalized graphene oxide-based nanosacks and/or delivery capsules encapsulating uni-functional, or bi-functional, or multifunctional sub-micron or nanoscale materials. The method can include introducing the smart self-dispersible nanosacks or capsules into a slug (e.g., water slug, liquified gas slug, natural gas liquids, diesel slug, and/or similar slugs) to create an “enhanced slug”. The enhanced slug containing the smart nanosack particles can function as a recovery fluid that can be introduced into subterranean hydrocarbon bearing formations to provide a site-specific and function-specific delivery of sub-micron particles into the formation to enhance the efficacy of stimulation and improve oil recovery.

The recovery fluid contains self-dispersible, non-functionalized, smart cargo particles that are dispersed into a slug (e.g., a water slug or other type of compatible slug). This slug can be passed through the subsurface formation containing hydrocarbons before, during and/or after the introduction of water, gas liquified gas, vaporized gas. This self-dispersible, non-functionalized smart cargo containing recovery fluid with site and function specific delivery vehicles provides a lower-cost, higher efficiency, environmentally friendly method for EOR compared to traditional solutions known in the art. For example, the self-dispersible, non-functionalized, smart cargo particles combine several functionalities into one modularity and can provide a very high efficiency of delivered cargo (“delivery efficiency”) when compared to surface treated nano particles, which typically offer delivery efficiencies of just 10-20%. The use of self-dispersible, non-functionalized, smart cargo particles can lead to delivery efficiencies of up to 80-90%.

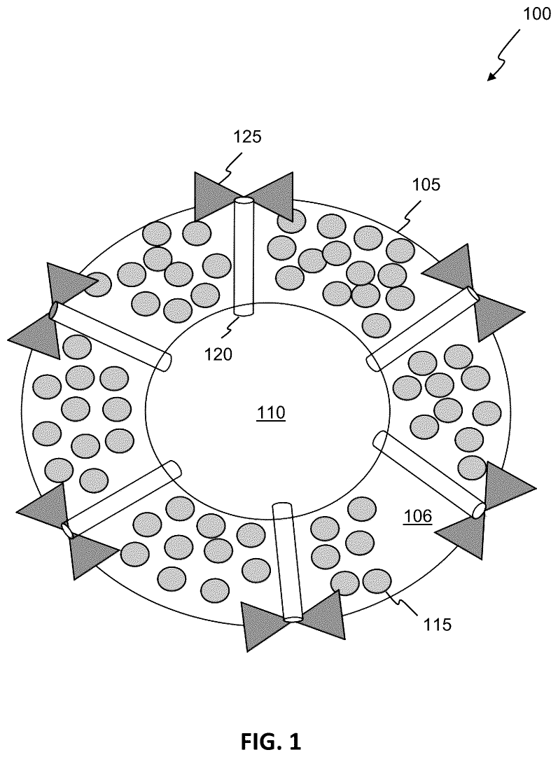

Turning now to the Figures. FIG. 1 depicts a sectional view of a smart, recoverable delivery vehicle (“delivery vehicle”), generally 100, for site-specific and function-specific precise delivery of sub-micron particles for enhanced oil recovery (“EOR”), according to some embodiments. Although not shown, the delivery vehicle 100 includes functional cargo (discussed below), which is removed from the illustration to facilitate the discussion. The delivery vehicle 100 is a hollow carbon-based structure that can be mixed with a dispersion fluid and injected into a subterranean residual oil zone. The delivery vehicle 100 can include an outer shell 105, an inner core 110, at least one channel 120, and a stimulus-responsive polymer 125. The outer shell 105 includes graphene sheets (e.g., graphene oxide sheets) interlocked together in a manner to thereby form a hollow spherical structure. The outer shell 105 is preferably negatively charged to facilitate their dispersal in a dispersion fluid. The inner core 110 is a hollow structure that stores functional cargo (discussed further below). In some embodiments, the channel 120 is a tubular polymeric structure that links the inner core 110 to the external environment of the delivery vehicle 100. In other embodiments, the channel 120 is an aperture or void in the outer shell 105 that forms during the formation of the delivery vehicle 100.

The channel 120 traverses the outer shell 105 and terminates at the inner core 110. The stimulus-responsive polymer 125 is a polymeric motif that can be externally positioned proximate to the outer shell 105. Applicable polymers that can be used as a stimulus-responsive polymer include, but are not limited to, polystyrene. The stimulus-responsive polymer 125 can be functionally coupled to the channel 120 in a manner that allows the stimulus-responsive polymer 125 to selectively block the channel 120. The stimulus-responsive polymer 125 can be configured to receive a stimulus and in response unblock the channel 120 to thereby allow functional cargo located in the inner core 110 to be released therefrom via the channel 120 into the external environment to the delivery vehicle 100 (e.g., the subterranean residual oil zone). The stimulus can be time-dependent and/or pH-dependent.

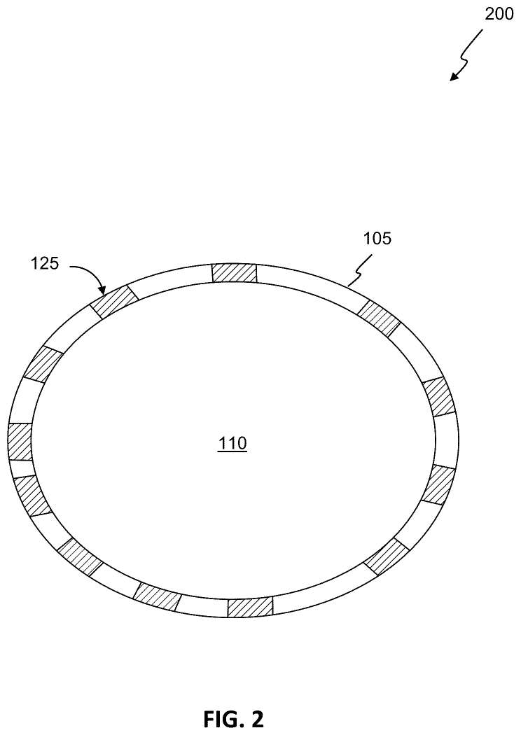

Hence, the stimulus-responsive polymer 125 can have a blocking state (i.e., a configuration that blocks the channel 120 and an access state (i.e., a configuration that unblocks the channel 120). The outer shell 105 can include magnetic responsive particles 115 to aid in the guidance of delivery vehicles within subterranean geological formations. The magnetic responsive particles 115 can be one or more metal oxides (e.g., iron oxide). FIG. 2 depicts a sectional view of a delivery vehicle, generally 200, according to other embodiments. The delivery vehicle 200 is a simpler version of and shares components with the delivery vehicle 100. The delivery vehicle 200 is also a cost-effective solution to fabricate compared to the delivery vehicle 100 because it requires less components. Similar to the delivery vehicle 100, the delivery vehicle 200 includes the outer shell 105, the stimulus responsive polymers 125, and the inner core 110.

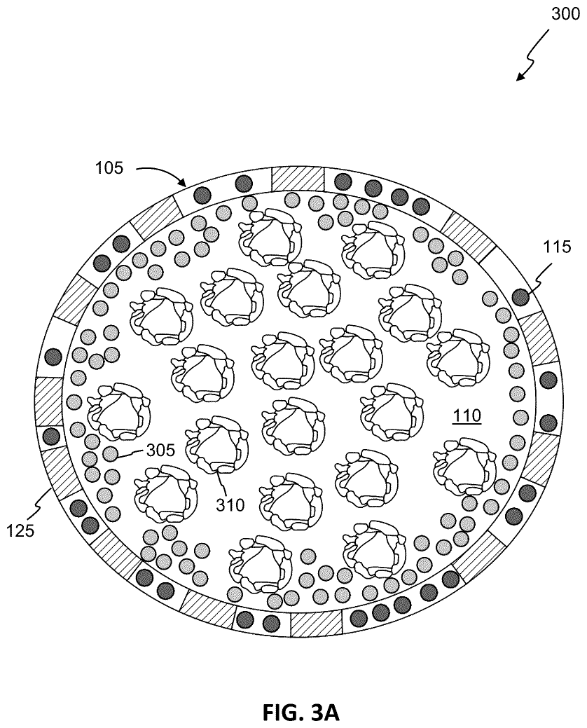

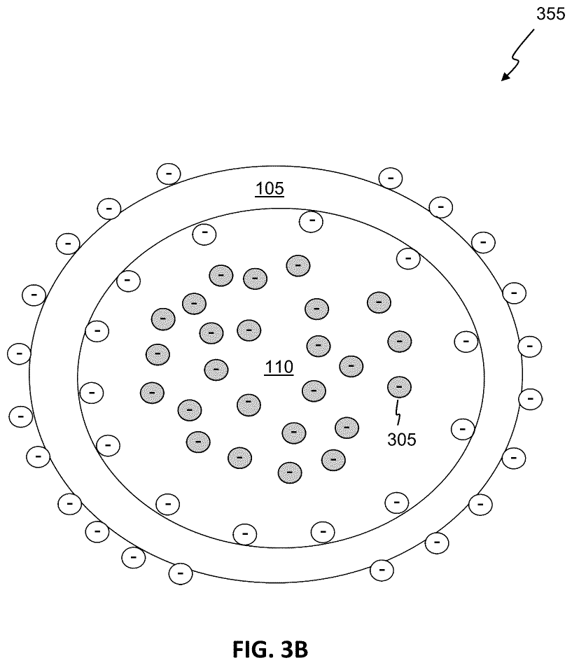

FIG. 3A depicts a sectional view of a delivery vehicle 300, according to certain embodiments. The delivery vehicle 300 shares some components and functionalities with the delivery vehicle 100 but includes additional components to facilitate the site- and function-specific precise delivery of functional cargo. The delivery vehicle 300 includes the outer shell 105, the stimulus responsive polymers 125, the magnetic responsive particles 115, and the inner core 110. The delivery vehicle 300 can also include functional cargo (e.g., silica nanoparticles 305 and crumpled three-dimensional graphene balls 310) positioned within the inner core 110 that is released therefrom to enhance oil recovery. As used herein the terms “crumpled three-dimensional graphene balls” and “graphene balls” are used interchangeably. The silica nanoparticles 305 function to assist in dislodging the oil from rock surfaces and/or residual oil zones by exerting disjoining pressure therein.

The graphene balls 310 function to absorb oil and act as a vehicle within which the oil is transported back to the surface to thereby enhance the recovery and oil sweep (i.e., the fraction of the reservoir or pore volume that is swept or invaded by the displacing fluid). In other words, the graphene balls 310 are recoverable once the oil is absorbed. FIG. 3B illustrates a charge distribution profile of a delivery vehicle, generally 355 that includes uni-functional cargo, according to yet still other embodiments. The delivery vehicle 355 includes the outer shell 105 and the inner core 110. The delivery vehicle 355 also includes the silica nanoparticles 305 positioned within the inner core 110. The outer shell 105 preferably includes graphene oxide sheets and thereby exhibits a negative charge; however, in contrast, the encapsulated bare silica nanoparticles 305 are negatively charged.

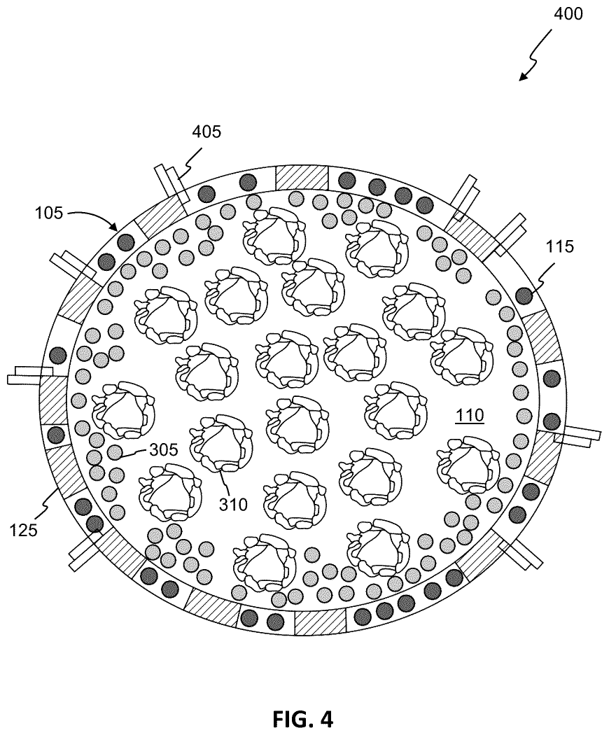

Not to be limited by theory, the negative-negative repulsion between the outer shell 105 can lead to a stabilization of the silica nanoparticles 305, which can provide a stable encapsulation. FIG. 4 depicts a sectional view of a delivery vehicle, generally 400, according to some embodiments. The delivery vehicle 400 includes all of the components of the delivery vehicle 300 and further includes an oxygen functionality 405 coupled to each of the stimulus responsive polymers 125. Applicable oxygen functionalities include, but are not limited to, hydroxyl, epoxy, and carboxylic. The oxygen functionalities 405 can enhance the dispersibility and solubility of the outer shell 105 (and hence, the delivery vehicle 400) in water.

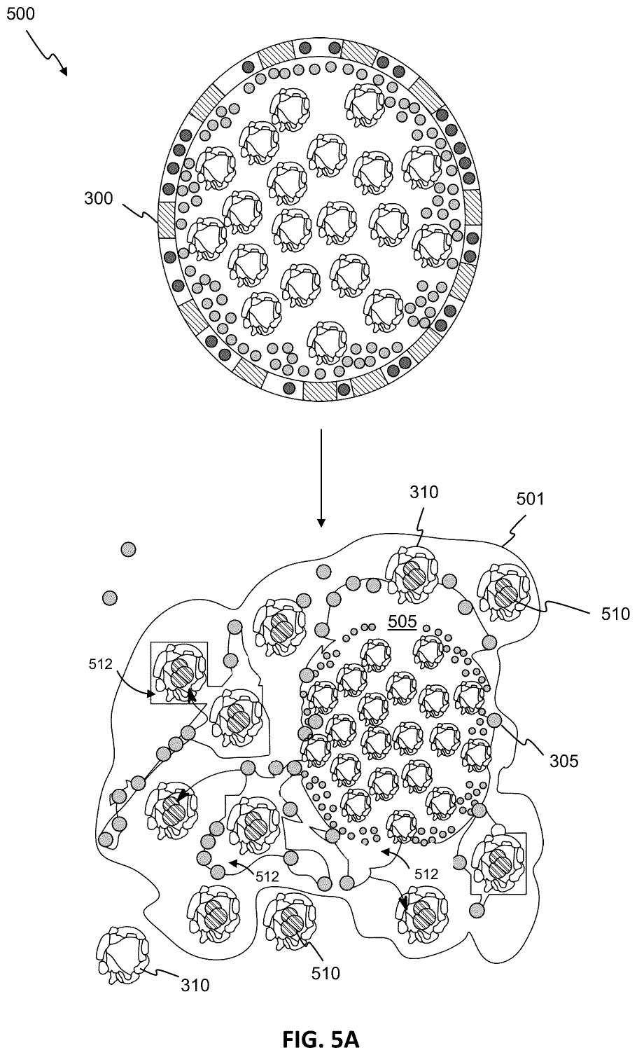

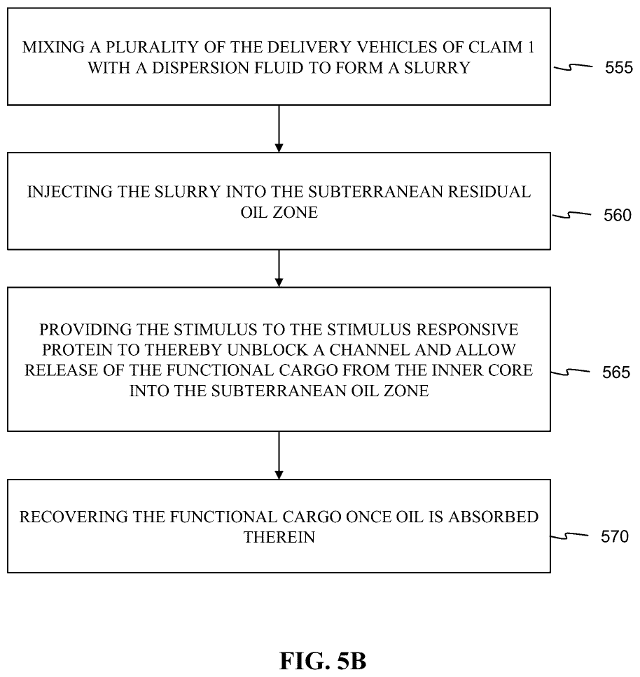

FIG. 5A depicts a flooding mechanism, generally 500, that uses the delivery vehicles of the instant disclosure for oil recovery in a subterranean residual oil zone, according to other embodiments. To be sure, FIG. 5A is not drawn to scale. The flooding mechanism 500 depicts the delivery vehicle 300 and a subterranean residual oil zone 505 (i.e., a porous oil-bearing geological formation) that includes residual oil 510 positioned in a plurality of voids 512 (i.e., pores or void spaces, which can contain air, water, hydrocarbons, or other fluids). The term “residual oil” refers to oil that can be found in low concentrations naturally or in exhausted oil fields. Often mixed with water, residual oil is typically not recoverable by conventional techniques. FIG. 5B illustrates operational steps of a method for recovering oil, according to certain embodiments. At Step 555, a plurality of delivery vehicles 300 are mixed with a dispersion fluid to form a slurry.

Applicable dispersion fluids include, but are not limited to, deionized water, brackish water, seawater, produced water, diesel, liquefied natural gas, produced gas, ethane, natural gas liquids, propane, liquid carbon dioxide or gaseous carbon dioxide. At Step 560, the slurry is injected into the subterranean residual oil zone 505). Once injected, the slurry can be magnetically guided to a predetermined location to lodge itself inside the voids 512. At Step 565, a stimulus is provided to the stimulus responsive polymers 125 to thereby cause each stimulus responsive polymer 125 to unblock a channel 120 and allow release of the functional cargo (e.g., the silica nanoparticles 305 and the graphene balls 310) from the inner core 110 into the subterranean oil zone 505 (i.e., the voids 512). For example, the stimulus responsive polymer 125 can be configured to degrade or change orientation after a predetermined time period (e.g., as measured in seconds, minutes, hours, days, and/or months). The stimulus responsive polymer 125 can be configured to degrade or change orientation when exposed to a predetermined pH or range thereof.

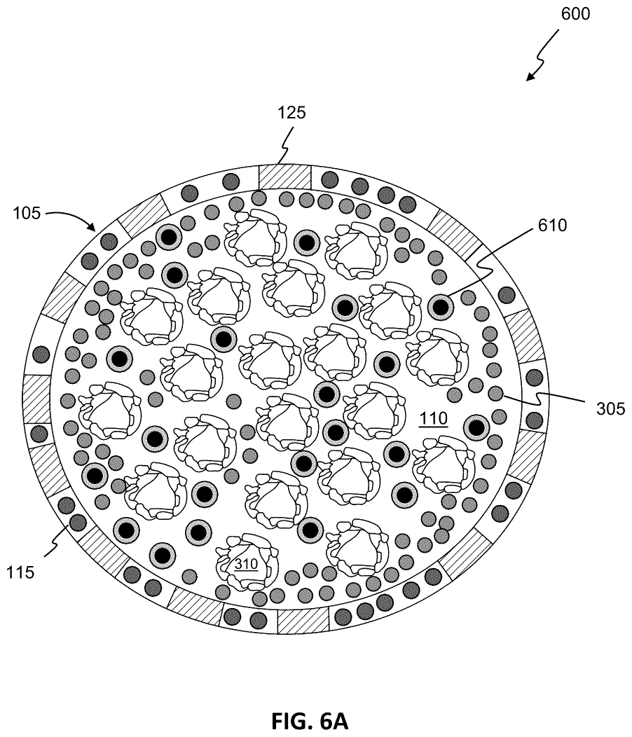

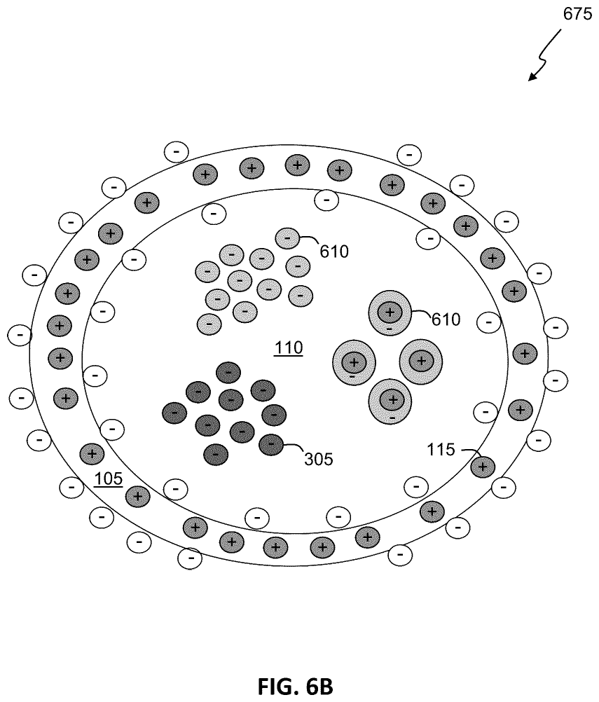

At Step 570, the functional cargo (e.g., the graphene balls 310 and the silica nanoparticles 305) is recovered once oil 510 is absorbed therein. For example, once the graphene balls 310 absorb the oil 510, they can be pumped out (e.g., using oil recovery techniques known in the art) of the residual subterranean oil zone 505 along with the silica nanoparticles 305. For example, pump down water, sand, and/or chemicals to create a zone of intense pressure around the oily layer of rock that includes the graphene balls 310. The intense pressure forces the oil out of the rock. The oil, being a liquid, moves along the tiny crevices between rocks towards a zone of low pressure. The process for the oil to move takes some time and during that time the pressure in the well gets reduced because the production team can stop pumping in and start pumping out with a pumpjack or other equipment. This turns the well into a zone of low pressure that the oil gradually moves towards and when it arrives at the well the only option it has is to go up the well and be pumped out. Once removed from the residual subterranean oil zone 505, the oil 510 can be removed from the graphene balls 310, and the graphene balls 310 and the silica nanoparticles 305 can be recycled. FIG. 6A depicts a sectional view of a delivery vehicle, generally 600, according to some embodiments. The delivery vehicle 600 includes all of the components of the delivery vehicle 300; however, the delivery vehicle 600 further includes wrapped iron particles 610, which are iron oxide particles that are wrapped in a silica shell. FIG. 6B illustrates a charge distribution profile, generally 675, of the multi-functional delivery vehicle 600, according to yet still other embodiments. Here, the outer shell 105 includes graphene oxide, which is negatively charged, and iron oxide particles 115, which are positively charged.

Not to be limited by theory, anchoring these particles in a graphene shell and opposite charge attraction provide a stable graphene oxide shell with ultra-fine particles of iron oxide, which impart the magnetic responsiveness to these structures. The inner core 110 includes the silica nanoparticles 305 and the iron particles 610. The silica nanoparticles 305 can function to dislodge the oil from geological formations and the wrapped iron particles 610 can function to stabilize foams for better flow distribution in sub-surface geological formations. The iron oxide particles 115 facilitate magnetically induced enhanced oil or improved oil recovery.

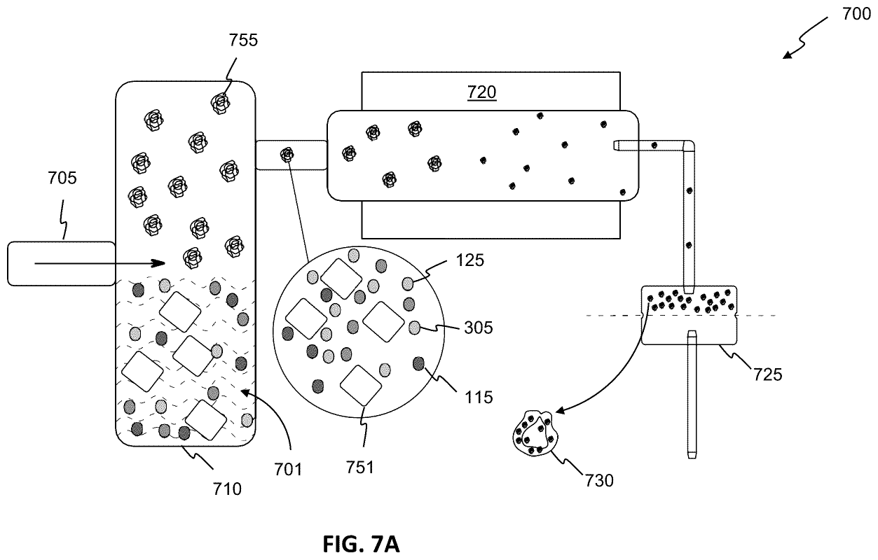

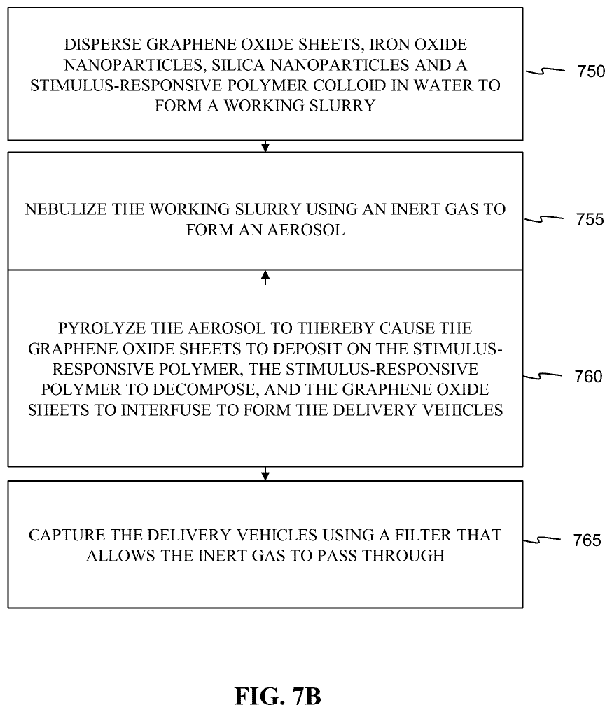

FIG. 7A depicts a process, generally 700, for generating delivery vehicles, according to some other embodiments. FIG. 7B illustrates operational steps of a method for the process 700, according to certain embodiments. At Step 750, graphene oxide sheets and multiple types of nanoparticles (e.g., graphene sheets 751, the iron oxide particles 115, the silica nanoparticles 305, and the wrapped iron particles 610) are dispersed in water (e.g., stored in a vessel 710) to form a working slurry. At Step 755, the working slurry is nebulized using a carrier gas (e.g., an inert gas) to form an aerosol (e.g., droplets 755). Applicable carrier gases, include, but are not limited to, noble gases. For example, the working slurry can be sonicated and the carrier gas fed therethrough to generate the droplets 755. For example, a carrier gas source 705 can be physically coupled to the vessel 710. At Step 760, the droplets 755 are pyrolyzed to thereby cause the graphene oxide sheets to deposit on the stimulus-responsive polymers 125, the stimulus-responsive polymers 125 to decompose, and the graphene oxide sheets to interfuse and thereby form the delivery vehicles 730. For example, the vessel 710 can be physically and functionally coupled to a heating element 720 (e.g., a tube furnace). The heating element 720 includes a gas inlet and a gas outlet. As the droplets suspended in the carrier gas pass through the heating element 720, the liquid water included therein evaporates and thereby generates thin graphene oxide shells around the nanoparticles. A filter 725 can be physically coupled to the exhaust end of the heating element 720 to capture the delivery vehicles.

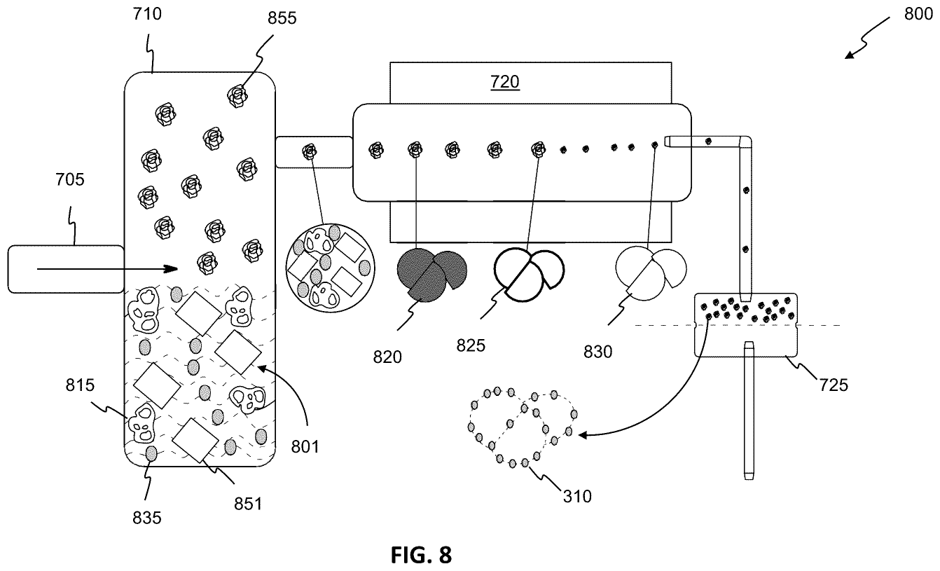

FIG. 8 depicts a process, generally 800, for generating the graphene balls 310, according to some other embodiments. The process 800 shares the same components, configurations, and functionalities with the process 700. However, unlike the process 700, the process 800 combines graphene sheets 851 (e.g., graphene oxide sheets), iron oxide particles 815, polymer colloids 835, and water in the vessel 710 to form a working slurry 801. The working slurry 801 can be sonicated and nebulized using the carrier gas to form droplets 855. The droplets 855 can pass through the heating element 720 (e.g., a fast pyrolysis furnace) where capillary evaporation leads to uniform deposition of the graphene sheets 851 on the polymer colloids 835 to form the graphene balls 310. The heating element 720 can be temperature adjusted to form 3D crumpled graphene balls that have varying degrees of hydrophobicity. For example, the heating element 720 can be configured to exhibit a temperature gradient as the droplets 855 traverse through the heating element 720. As the temperature of the heating element 855 changes (e.g., increases), the oxygen functionalities of the graphene oxide sheets are reduced such that the reduction of graphene balls 830 is greater than that of graphene balls 825, which is greater than that of graphene balls 820. As the polymer colloids 835 decompose in the high heat environment it creates minor openings in the graphene oxide shell making it suitable for absorbing residual oil from sub-surface geological formations.

Based on the foregoing, delivery vehicles for use in oil recovery and methods of use have been disclosed. However, numerous modifications and substitutions can be made without deviating from the scope of the instant disclosure. Therefore, the instant disclosure has been disclosed by way of example and not limitation.

What is claimed is:

1. A delivery vehicle for site-specific and function-specific precision delivery of sub-micron cargo for petroleum recovery comprising:
an outer shell;
inner core;
a channel;
a functional cargo;
a stimulus-responsive polymer;
wherein
the delivery vehicle is configured to be mixed with a dispersion fluid and injected into a subterranean residual oil zone;
the outer shell
comprises graphene oxide sheets and/or graphene sheets interlocked together in a manner to form a spherical structure;
is negatively charged;
the channel traverses the outer shell and terminates at the inner core;
the functional cargo absorbs petroleum;
the stimulus-responsive polymer;
is externally positioned on the outer shell;
is functionally coupled to and selectively blocks the channel; and
is configured to unblock the channel when a stimulus is received and thereby allows the functional cargo to be released from the inner core via the channel into the subterranean residual oil zone.

2. The delivery system of claim 1, wherein
the outer shell comprises magnetic responsive particles.

3. The delivery system of claim 2, wherein
the magnetic responsive particles comprise iron oxide.

4. The delivery system of claim 1, wherein
the functional cargo comprises crumpled graphene balls;
the crumpled graphene balls;
absorb petroleum; and
are recoverable once the petroleum is absorbed.

5. The delivery system of claim 1, wherein
the functional cargo comprises silica nanoparticles.

6. The delivery system of claim 5, wherein
the silica nanoparticles are present as a shell that surrounds a metal particle.

7. The delivery system of claim 1, wherein
the stimulus-responsive protein comprises an oxygen-containing functional group.

8. The delivery system of claim 1, wherein
the stimulus is one or more of time-dependent and pH-dependent.

9. A method for recovering oil, comprising:
mixing a plurality of the delivery vehicles of claim 1 with a dispersion fluid to form a slurry;
injecting the slurry into the subterranean residual oil zone;
providing the stimulus to the stimulus responsive protein to thereby unblock a channel and allow release of the functional cargo from the inner core into the subterranean oil zone; and
recovering the functional cargo once oil is absorbed therein.

10. The method of claim 9, further comprising:
forming the delivery vehicles.

11. The method of claim 10, wherein forming the delivery vehicles comprises:
dispersing graphene oxide sheets, iron oxide nanoparticles, silica nanoparticles and a stimulus-responsive polymer colloid in water to form a working slurry;
nebulizing the working slurry using an inert gas to form an aerosol;
pyrolyzing the aerosol to thereby cause the graphene oxide sheets to deposit on the stimulus-responsive polymer, the stimulus-responsive polymer to decompose, and the graphene oxide sheets to interfuse to form the delivery vehicles, each delivery vehicle comprising the functional cargo surrounded by a graphene oxide shell, the functional cargo comprising graphene oxide micro-capsules and the silica nanoparticles, the delivery vehicle comprising a negative charge distribution profile; and
capturing the delivery vehicles using a filter that allows the inert gas to pass through.

12. The method of claim 11, wherein
the silica nanoparticles comprise modified silica nanoparticles; and
the modified silica nanoparticles comprise iron-oxide nanoparticles surrounded by silica nanoparticles.
